(19) United States
(12) Patent Application Publication
(10) Pub. No.: US 2010/0294428 A1
(43) Pub. Date: Nov. 25, 2010

(54) Method of Integrating Electrochemical Devices Into and Onto Fixtures

(76) Inventors: Shawn W. SNYDER, Golden, CO (US); Joseph A. Keating, Broomfield, CO (US); Paul C. Brantner, Conifer, CO (US); John T. Than, Denver, CO (US); Bernd J. Neudecker, Littleton, CO (US)

Correspondence Address: Dewey & LeBoeuf LLP, 1101 New York Avenue, NW, Washington, DC, 20005, US

(21) Appl. No.: 12/784,287

(22) Filed: May 20, 2010

Related U.S. Application Data
(60) Provisional application No. 61/179,953, filed on May 20, 2009.

(51) Int. Cl. C09J 5/06

(52) U.S. Cl. 156/321

(57) ABSTRACT

Methods of integrating an electrochemical device to a fixture are disclosed. When performed, these methods may, for example, result in the improved performance and/or extended shelf life of the electrochemical device. These methods may include, for example, discharging an electrochemical device prior to an integration process, limiting the temperature exposure of the electrochemical device during the integration process, and/or applying a constraining force to a surface of the electrochemical device during an integration process.

### RELATED APPLICATIONS

The present application is related to and claims the benefit under 35 U.S.C. §119(e) of U.S. provisional patent application Ser. No. 61/179,953, filed May 20, 2009, which is expressly incorporated fully herein by reference.

### TECHNICAL FIELD

This invention relates to a method of integrating electrochemical devices into and onto fixtures. In particular, the present invention relates to, for example, a method of integrating electrochemical devices into and onto fixtures by applying heat and pressure over a period of time while maintaining the electrochemical performance of the electrochemical devices.

### BACKGROUND OF THE INVENTION

As new manufacturing techniques are making electrochemical devices such as thin-film batteries smaller and thinner, these devices are now able to be integrated into or onto other electronic devices or fixtures. Some examples of electronic devices or fixtures are printed circuit boards, flexible printed circuit boards, semiconductor chips, multi-layer printed circuit boards, smart cards, credit cards, polymeric and non-polymeric laminates, casts, injection molds, silicon wafers, silicon wafer sandwiches, silicon wafer laminates, ceramic holders and metallic holders.

Consequently, the electrochemical device itself is subjected to thermal and mechanical stresses when it is, for example, laminated, cast, or injection molded as a component of a larger device. Additionally, the electrochemical device undergoes thermal and mechanical stresses when it is affixed to an electronic device or fixture by solder reflow processing, welding or various other connection methods.

Certain adverse effects have been observed when integrating some electrochemical devices into or onto electronic devices and fixtures by means of applying heat and/or pressure. In some examples the encapsulation mechanically and thermally deforms in a different manner than the other parts of the thin-film battery. Thus, the encapsulation's integrity and performance may become at least temporarily compromised. In other words, such deformation may prevent the electrochemical cell from remaining intact such that the cell's layers detach or delaminate from each other. During this period of lost integrity ambient reactants may penetrate the electrochemical device encapsulation, come into contact with environmentally-sensitive components inside the electrochemical device (e.g., electrodes and/or electrolyte) and, consequently, reduce the performance of the electrochemical device.

It has also been observed that certain levels of charge voltage on an electrochemical device, the voltage necessary to charge the electrochemical device, may place at least one of the electrode materials (anode and/or cathode) into a meta-stable state. A “meta-stable state” is, for example, the state of at least one electrode once an electrochemical cell is charged. For example, for an electrochemical cell with a Li anode, a Lipon electrolyte and a LiCoO₂ cathode, LiₓCoO₂ is the meta-stable electrode where x≧0 and x<1.0 (as x decreases, the state of charge increases); on the other hand, the chemical state of the metallic Li anode does not change when the state of charge of the cell or the state of charge of the cathode is changed. As the state of charge increases, the electrode in this example becomes further away from its thermodynamic equilibrium (and the higher its meta-stable state is above thermodynamic equilibrium in terms of energy). In such a state, exposure to elevated temperatures and/or pressures over time may increase the chemical reactivity of the electrode materials with other components in the electrochemical device such as, for example, the electrolyte, which could lead to premature material decomposition. More specifically, whether or not the meta-stable state of a given solid state material decomposes is generally a matter of the temperature and time applied to the material. If the temperature is high enough and/or the time applied is long enough, decomposition of the meta-stable electrode may occur according to nature's objective to reach a fully stable state. Alternatively, the meta-stable electrode may react with surrounding chemicals, such as the electrolyte, current collectors or cell packaging, thereby again moving from the meta-stable state to a stable state. The consequences of this condition may be similar to an electrochemical device in an overcharge condition.

Thus, there is, for example, a demand for a method of integrating electrochemical cells into or onto devices and electronic fixtures in a way that will minimize or avoid the aforementioned adverse effects.

### SUMMARY OF INVENTION

It is one object of certain exemplary embodiments of this invention to overcome the aforementioned adverse effects. Certain embodiments, as discussed in further detail below, may involve, for example, methods of discharging an electrochemical device prior to the integration process, limiting the temperature exposure of an electrochemical device during the integration process and/or applying a constraining force to a surface of an electrochemical device during the integration process.

A method of integrating an electrochemical device with a fixture according to some embodiments of the present invention includes providing an electrochemical device comprising a negative electrode, an electrolyte, and a positive cathode where the positive cathode has a charge state that is less than the upper stability limit of the charge state of the positive cathode at room temperature; providing a fixture; heating the fixture and the electrochemical device at a temperature for a time period; and affixing the electrochemical device to the fixture.

A method of integrating an electrochemical device with a fixture according to some embodiments of the present invention includes providing an electrochemical device where the electrochemical device was fabricated in its stable state and has not been previously charged; providing a fixture; heating the fixture and the electrochemical device at a temperature for a time period; and affixing the electrochemical device to the fixture.

These and other embodiments of the invention are further discussed below with reference to the following figures. Both the foregoing general description and the following detailed description are exemplary and exemplary only and are not restrictive of the invention, as claimed. Further, specific explanations or theories regarding the integration methods according to the present invention are presented for explanation only and are not to be considered limiting with respect to the scope of the present disclosure or the claims.

### BRIEF DESCRIPTION OF THE DRAWINGS

FIG. 1 illustrates an example of the relationship between charge state of a LiCoO₂ cathode material and its voltage as measured versus a virtual or actual metallic Lithium reference electrode according to certain embodiments of the present invention.

FIG. 2 illustrates an example of the relationship between charge state of a LiCoO₂ cathode material given in voltage as measured versus a virtual or actual metallic Lithium reference electrode, and the maximum allowable integration temperature at which the LiCoO₂ cathode material remains stable for about one hour according to embodiments of the present invention.

### DETAILED DESCRIPTION OF PREFERRED EMBODIMENTS

The present invention is not limited to the particular methodology, compounds, materials, manufacturing techniques, uses, and applications described herein as they may vary. The terminology used herein is used for the purpose of describing particular embodiments only and is not intended to limit the scope of the present invention. As used herein and in the appended claims, the singular forms “a,” “an,” and “the” include the plural reference unless the context clearly dictates otherwise. For example, a reference to “an element” is a reference to one or more elements, and includes equivalents thereof known to those skilled in the art. Similarly, for another example, a reference to “a step” or “a means” is a reference to one or more steps or means and may include sub-steps or subservient means. All conjunctions used are to be understood in the most inclusive sense possible. For example, the word “or” should be understood as having the definition of a logical “or” rather than that of a logical “exclusive or” unless the context clearly necessitates otherwise. Structures described herein also refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices and materials are described although any methods, techniques, devices or materials similar or equivalent to those described may be used in the practice or testing of the present invention. Structures described herein also refer to functional equivalents of such structures.

All patents and other publications are incorporated herein by reference for the purpose of describing and disclosing, for example, the methodologies described in such publications that may be useful in connection with the present invention. Such publications are provided solely for their disclosure prior to the filing date of the present application. Nothing in this regard should be construed as an admission that the inventors are not entitled to antedate such disclosure by virtue of prior invention or for any other reason.

One solution to maintain the integrity of the electrochemical device during a heat-intensive and pressure-intensive integration process may be to ensure that the electrochemical device is in a less meta-stable condition. As mentioned above, charging a battery may be equivalent to forcing at least one of the electrode materials (anode and/or cathode) into a meta-stable state. When a charged battery is subjected to elevated temperatures and pressures over a certain time period, the electrode materials may become reactive with other components in the electrochemical device, such as, for example, the electrolyte. As well, the meta-stable electrode materials may decompose without reacting with any other components in the electrochemical device. Electrochemical device components may be placed in a more stable condition and may therefore be less reactive when subjected to heat and pressure by discharging the battery prior to the integration process. Electrochemical device components may also be placed in a more stable condition by providing the battery in the proper charge state through any form of the preceding operation, such as, for instance, charging the battery only up to a given charge state.

In at least one preferred embodiment of the present invention, the electrochemical device is placed in the least-possible charged state prior to being subjected to the heat-intensive and pressure-intensive integration process into the fixture. For example, the fully-charged open-circuit voltage may be about 4.2V at 25° C. for a battery with a Li anode, a Lipon electrolyte and a LiCoO₂ cathode. An exemplary lithium thin-film battery is discussed, for example, in U.S. application Ser. No. 12/179,701 entitled “Hybrid Thin Film Battery,” which is incorporated herein by reference in its entirety. If the battery charge is at a voltage of less than about 4.2V (ideally in the range of 1.3-3.7V), the battery components may remain chemically stable at high temperatures and/or pressures for a period of time.

In an exemplary battery equipped with a metallic lithium anode and a lithium transition metal oxide cathode, such as LiCoO₂, the cathode may be driven into a meta-stable charge state upon charging, because the metallic Li anode may not change its chemical nature upon battery charge but simply remain metallic Li.

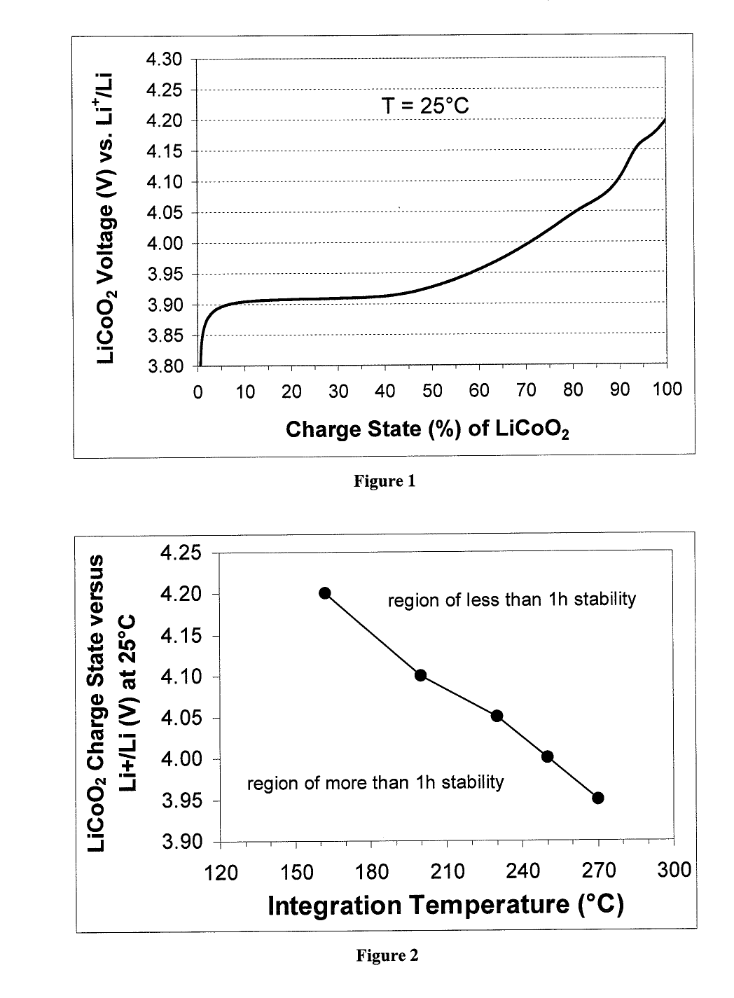

FIG. 1 illustrates, for example, the relationship between charge state of a LiCoO₂ cathode as a function of voltage versus a virtual metallic Li reference electrode or an actually existing metallic Li anode for certain preferred embodiments of the present invention. For charge states of larger than zero, the LiCoO₂ cathode may become meta-stable and this meta-stability increases with increasing charge state. Moreover, the meta-stability of a LiCoO₂ cathode may further increase when increasing the temperature for a given charge state.

It is understood that meta-stability means, for example, that a chemical (i) reacts on a specific time scale (even if this scale is hundreds of years) for a given temperature and given degree of meta-stability and (ii) reacts quickly (a matter of minutes or hours) when surpassing a given threshold temperature for a given meta-stability. As such, a charged LiCoO₂ in the present invention may, for example, react or self-decompose more or less quickly depending on the surrounding temperature and its given charge state.

FIG. 2 illustrates, for example, the relationship between integration temperature and time for an exemplary LiCoO₂ cathode as a function of its charge state for certain preferred embodiments of the present invention. As seen in FIG. 2, for certain embodiments, the line denotes the maximum temperature that a LiCoO₂ may sustain for about one hour for certain charge states without incurring substantial chemical reaction, including self-decomposition. Viewed differently, FIG. 2 shows the maximum charge state (in volts) of an exemplary LiCoO₂ cathode for a given integration temperature for the LiCoO₂ cathode to remain without substantial damage for about one hour. The integrator that is assembling the electrochemical device to the electronic device or fixture may reference FIG. 2 when working with a LiCoO₂ cathode, or a similar chart that is specific to the electrochemical device that is being integrated, to determine the temperature and times that are safe to expose the electrochemical device. Additionally, as illustrated in FIG. 2, the integrator may be able to increase the temperature and/or time of exposure by adjusting the electrochemical device to a certain voltage.

FIG. 1 shows that the upper stability limit of a charged LiCoO₂ cathode at room temperature (e.g. 9° C.-27° C.) is at a voltage potential of about 4.2V when measured in comparison to a virtual lithium reference electrode (i.e., Li⁺/Li) or actual lithium anode. A virtual lithium reference electrode is used in this example because of its well-known electrode potential and it is understood that various embodiments of this invention may be applied to batteries with anodes comprising different materials such as, for example, carbon, magnesium and/or titanium. As each anode material has different electrochemical properties and electrode potential, the cell voltage at which the LiCoO₂ electrode will reach its upper stability will vary depending upon the anode material used. Therefore, the voltages discussed with respect to the virtual lithium reference electrode are used for purposes of simplicity and with the understanding that a person skilled in the art would have the ability to translate these voltage values into those usable for batteries with other anode materials.

Certain cell phone batteries have a maximum charge voltage of 4.2V when equipped with a LiCoO₂ cathode, which exemplifies that 4.2V is a generally accepted as the upper stability value for LiCoO₂ at room temperature. Complementing FIG. 1, FIG. 2 shows to which charge state the upper stability limit of LiCoO₂ may be reduced when the temperature is substantially increased above room temperature. FIG. 2 focuses on an exemplary stability time of about one hour, but similar charts can be obtained for different stability times. For instance, when reducing the stability time of interest from one hour to three minutes, one may subject a charged LiCoO₂ of 4.1V up to about 270° C. instead of only 200° C.

In one embodiment according to the present invention, the integration temperature may be raised above room temperature to at least 70° C. without significant degradation of the electrochemical cell. In another embodiment according to the present invention, the integration temperature may more preferably be raised to at least 150° C., at which temperature the integrator may use an integration (dwell) time of, for example, about one hour. In another embodiment of the present invention, the integration temperature may most preferably be raised to at least 260° C., which may be desired for the use of lead-free solder reflow processing. The dwell times at such temperatures can be, for example, less than two minutes. At such temperatures, electronic modules may be soldered into circuits, for example, using automated soldering equipment. Reflow soldering is an exemplary method of attaching electrochemical devices to printed circuit boards, but other methods may be used according to the present invention. Reflow soldering may include temporarily attaching one or more components to their contact pads and heating the assembly, using a reflow oven, infrared lamp, hot air pencil, among other devices, to melt the solder and permanently connect the joints. Different solder types require different minimum temperatures and typically range from about 190° C. for a few minutes (tin-lead based solders) to 265° C. for up to 2 minutes (lead-free solders). The goal of the reflow process may include preventing overheating and subsequent damaging of the electrochemical and other components of the system.

To discharge the electrochemical device to a specific charge state in preparation for a targeted device integration period, an integrator may first connect a voltage meter to the positive and negative terminals of the electrochemical device and measure the voltage. A resistive load may then be connected across the terminals of the electrochemical device. In one preferred embodiment, a 42 kΩ (+/−1 k) resistor may be connected across the terminals of a thin-film battery. As the resistive load is connected to the terminals, the voltage of the meter may decrease as the electrochemical device discharges. When the voltage meter reads a voltage value that is commensurate to the temperature-time curve that the integrator chooses, the integrator can remove the resistive load and continue with the integration.

In another embodiment, the integrator may never test or operate the electrochemical device, which may be equipped with a metallic Li anode and a LiCoO₂ cathode, at more than 4.1V when integrating it into a printed circuit board at 200° C. for about one hour. Such an approach may automatically allow the integration of the electrochemical device at any time during its operational life.

In other embodiments, the electrochemical device may not be charged between the time that it was manufactured and the time that it was integrated onto a fixture. For example, the thin-film battery discussed above has a terminal voltage of approximately 1.3-3.7V prior to its first charge. Incidentally, this voltage range may be similar to a subtly charged or deeply discharged Li/LiCoO₂ battery wherein the LiCoO₂ cathode may exhibit slightly different chemical and physical properties as a never-before-charged LiCoO₂ cathode. Thus, one preferred method may include integrating this battery with the fixture prior to its first charge. This solution may not always be possible, however, given that there may be a desire to, for example, conduct performance tests on the battery before integrating it with the fixture which could include charging the battery.

Another exemplary solution to assist in maintaining the integrity of an electrochemical device when subjected to heat and pressure during the integration process may include, for example, providing preferably uniform pressure to one major surface of the electrochemical device. In electrochemical devices, for example, which may contain environmentally-sensitive materials such as Lithium, the integrity of the battery may depend upon an encapsulation or hermetic barrier between the electrochemical components and the atmosphere. One example of an encapsulation design is disclosed in U.S. application Ser. No. 12/151,137, which is incorporated herein by reference in its entirety. When subjected to temperatures, pressures and shear forces that are typical to the integration processes, the encapsulation may mechanically and thermally deform in a different manner than the rest of the parts of the electrochemical device. Thus, the temperatures, pressures and shear forces may compromise the integrity and performance of the encapsulation, at least temporarily. During this period of lost integrity, ambient reactants may penetrate the thin-film battery encapsulation and react with the environmentally-sensitive materials inside the device and, consequently, reduce the performance of the battery. This mechanical and thermal deformation of the encapsulation may be avoided, for example, by constraining the possible movement of the encapsulation, or fixating the encapsulation, relative to the rest of the electrochemical device during the heating and pressurizing integration process. Constraining the movement of the encapsulation may or may not utilize hydraulic or non-hydraulic compression. The mechanical constraining may, for example, temporarily provide an additional mechanical force on the encapsulation layer seal during the integration process. The amount of additional mechanical force may only be slightly greater than the amount of force caused by the thermal deformation.

This invention has been described herein in several embodiments. It is evident that there are many alternatives and variations that can embrace the performance of materials such as, for example, ceramics enhanced by the present invention in its various embodiments without departing from the intended spirit and scope thereof. The embodiments described above are exemplary only. One skilled in the art may recognize variations from the embodiments specifically described herein, which are intended to be within the scope of this disclosure. As such, the invention is limited only by the following claims. Thus it is intended that the present invention cover modifications of this invention provided that they come within the scope of the appended claims and their equivalents.

What is claimed is:

1. A method of integrating an electrochemical device with a fixture comprising:
providing an electrochemical device comprising a negative electrode, an electrolyte, and a positive cathode, said positive cathode having a charge state that is less than the upper stability limit of the charge state of said positive cathode at room temperature;
providing a fixture;
heating said fixture and said electrochemical device at a temperature for a time period; and
affixing said electrochemical device to said fixture.

2. The method of claim 1, wherein said temperature comprises above about 70° C.

3. The method of claim 1, wherein said temperature comprises above about 150° C.

4. The method of claim 1, wherein said temperature comprises solder reflow processing temperatures.

5. The method of claim 4, wherein said temperature comprises above about 260° C.

6. The method of claim 1, wherein said electrochemical device comprises lithium.

7. The method of claim 6, wherein said positive cathode comprises lithium.

8. The method of claim 7, wherein said positive cathode comprises LiCoO₂.

9. The method of claim 8, wherein said upper stability limit comprises about 4.2V measured against said negative electrode.

10. The method of claim 9, wherein said negative electrode comprises a virtual lithium reference electrode.

11. The method of claim 9, wherein said negative electrode comprises a metallic lithium anode.

12. The method of claim 9, wherein said temperature comprises up to about 160° C. and said time period comprises about one hour.

13. The method of claim 10, wherein said temperature comprises up to about 160° C. and said time period comprises about one hour.

14. The method of claim 11, wherein said temperature comprises up to about 160° C. and said time period comprises about one hour.

15. The method of claim 8, wherein said upper stability limit comprises about 4.1V measured against said negative electrode.

16. The method of claim 15, wherein said negative electrode comprises a virtual lithium reference electrode.

17. The method of claim 15, wherein said negative electrode comprises a metallic lithium anode.

18. The method of claim 15, wherein said temperature comprises up to about 200° C. and said time period comprises about one hour.

19. The method of claim 16, wherein said temperature comprises up to about 200° C. and said time period comprises about one hour.

20. The method of claim 17, wherein said temperature comprises up to about 200° C. and said time period comprises about one hour.

21. The method of claim 8, wherein said upper stability limit comprises about 4.05V measured against said negative electrode.

22. The method of claim 21, wherein said negative electrode comprises a virtual lithium reference electrode.

23. The method of claim 21, wherein said negative electrode comprises a metallic lithium anode.

24. The method of claim 21, wherein said temperature comprises up to about 230° C. and said time period comprises up to about one hour.

25. The method of claim 22, wherein said temperature comprises up to about 230° C. and said time period comprises up to about one hour.

26. The method of claim 23, wherein said temperature comprises up to about 230° C. and said time period comprises up to about one hour.

27. The method of claim 8, wherein said upper stability limit comprises about 4.0V measured against said negative electrode.

28. The method of claim 27, wherein said negative electrode comprises a virtual lithium reference electrode.

29. The method of claim 27, wherein said negative electrode comprises a metallic lithium anode.

30. The method of claim 27, wherein said temperature comprises up to about 250° C. and said time period comprises up to about one hour.

31. The method of claim 28, wherein said temperature comprises up to about 250° C. and said time period comprises up to about one hour.

32. The method of claim 29, wherein said temperature comprises up to about 250° C. and said time period comprises up to about one hour.

33. The method of claim 8, wherein said upper stability limit comprises about 3.95V measured against said negative electrode.

34. The method of claim 33, wherein said negative electrode comprises a virtual lithium reference electrode.

35. The method of claim 33, wherein said negative electrode comprises a metallic lithium anode.

36. The method of claim 33, wherein said temperature comprises up to about 270° C. and said time period comprises up to about one hour.

37. The method of claim 34, wherein said temperature comprises up to about 270° C. and said time period comprises up to about one hour.

38. The method of claim 35, wherein said temperature comprises up to about 270° C. and said time period comprises up to about one hour.

39. The method of claim 1, wherein said heating further comprises applying said temperature uniformly to at least one major surface of said electrochemical device.

40. The method of claim 1, further comprising:
fixating said electrochemical device in a manner that substantially prevents mechanical distortion of said electrochemical device.

41. The method of claim 1, further comprising:
compressing said electrochemical device in a manner that substantially prevents mechanical distortion of said electrochemical device.

42. The method of claim 41, wherein said compressing further comprises applying hydraulic pressure.

43. The method of claim 1, wherein said fixture comprises an item selected from the group of: printed circuit board, flexible printed circuit board, chip, multi-layer printed circuit board, multi-layer flexible printed circuit board, smart card, credit card, polymeric laminate, non-polymeric laminate, cast, injection mold, silicon wafer, silicon wafer sandwich, silicon wafer laminate, ceramic holder, metallic holder.

44. A method of integrating an electrochemical device with a fixture comprising:
providing an electrochemical device, said electrochemical device having not been previously charged;
providing a fixture;
heating said fixture and said electrochemical device at a temperature for a time period; and
affixing said electrochemical device to said fixture.
